(19) United States
(12) Patent Application Publication
(10) Pub. No.: US 2018/0096065 A1
(43) Pub. Date: Apr. 5, 2018

(54) Media Searching

(71) Applicant: Microsoft Technology Licensing, LLC, Redmond, WA (US)

(72) Inventors: Paramveer Singh Sisodia, Hyderabad (IN); Anubhav Mehendru, Hyderabad (IN); Nehal Tare, Hyderabad (IN)

(73) Assignee: Microsoft Technology Licensing, LLC, Redmond, WA (US)

(21) Appl. No.: 15/401,766

(22) Filed: Jan. 9, 2017

(30) Foreign Application Priority Data
Sep. 30, 2016 (IN) 201641033528

(51) Int. Cl. G06F 17/30

(52) U.S. Cl. CPC G06F 17/30778; G06F 17/30761; G06F 17/30631; G06F 17/30746

(57) ABSTRACT

A system and method for indexing media files to allow for more efficient searching. Speech or language contained in such files can be extracted and transcribed to text, to allow words or phrases to be indexed against the relevant files. Such an indexing system can be used alone, or in combination with other metadata such as length of file or place and/or date of capture or creation. The searching and indexing method finds particular application in the context of searching media files shared via instant messaging (IM).

### RELATED APPLICATIONS

This application claims priority under 35 USC 119 or 365 to Indian Patent Application No. 201641033528 filed Sep. 30, 2016, the disclosure of which is hereby incorporated by reference in its entirety.

### BACKGROUND

The present invention relates to indexing and searching media, and particularly multimedia files.

Multimedia content, and particularly video content, is becoming ever more prevalent in daily life, with vast quantities of video data available on the internet, and mobile devices being able to capture, store, and share video efficiently. Social media, and social networking and communication applications further encourage distribution of videos among users, and user devices.

However available options for searching multimedia files are limited. These include simply searching by file name which requires a user to remember the name or date of a file, and/or to manually tag or caption a video. Where files are used in the context of social media, searching by user or sender may also be possible.

Especially with audio and video, there is no easy and intuitive way to preview files, in the way that thumbnails allow images to be previewed, and to check if a retrieved file is in fact what is desired may require a user to play the file for a number of seconds or more.

### SUMMARY

It has been found that the above problem is especially experienced in relation to instant messaging (IM). IM is a communication method and set of technologies which offers real time text transmission between two or more participants over a network, such as the internet. IM allows effective and efficient communication, usually allowing immediate receipt of acknowledgment or reply. However, IM is not necessarily supported by transaction control. It is usually possible to save a text conversation for later reference. Instant messages are often logged in a local message history, making it similar to the persistent nature of emails. IM typically also supports communication of multimedia files such as images and videos, and therefore, as part of a message history a large number of such files may be accumulated on a user device or a server supporting an IM service (or both).

It is therefore desirable to provide improved searching/indexing of multimedia data.

Accordingly, in a first aspect there is provided a method of search indexing a media file comprising obtaining a media file including an audio component; extracting the audio component from the media file; converting recognized language in the extracted audio into text; and indexing at least some of the text as search terms against the media file.

In this way, context information derived from audio can be automatically extracted from media files, and can be searched against for simple and efficient retrieval.

In one embodiment, the method further comprises filtering the text so extracted to reduce the number of words indexed. Filtering may for example be performed to remove so called “stop words” which are words which are very common in a particular language but carry no contextual information (i.e. they do not provide information of the content or subject of the file which may be useful for search purposes). Such words are typically conjunctions, articles, prepositions etc. such as “and”, “but”, “she”, “in”, “on” etc. A list of such words may be made available to allow them to be excluded. In embodiments, filtering may also comprise removing duplicate words.

The method further comprises storing information on the frequency of words of indexed text, in embodiments. Thus words which are used a large number of times can be given greater significance or importance, and this information can be used in searching and/or presenting search results.

Conversion of recognized language in the extracted audio into text may be performed locally, on the device where media is obtained and indexed, or may be performed remotely. Remote performance may be by a server or cloud service for example, connected to a local device by a network. Requests or calls for such a service can be sent over the network, and results received back via the network.

In embodiments the method further comprises extracting metadata from the media file and indexing extracted metadata against that file. Such metadata includes, for example, date or time of creation of the media file, or the format of the media file.

The index, or indexed text can be integrated into a multimedia gallery of a user device in embodiments. This may include the creation or provision of a user interface to allow entry of search terms. Accordingly, in embodiments the method may further comprise receiving, from a user, at least one search term, searching said term against the indexed text, and returning matching media files. In embodiments the method further comprises ordering the returned files according to frequency of matched search terms.

In embodiments, the method is integrated with, or provided as part of or in conjunction with a messaging service such as instant messaging (IM). In some embodiments therefore, obtaining a media file comprises receiving said file via an instant messaging service, and in embodiments the index is integrated into the gallery of or associated with a messaging service.

The audio, or the recognized language in the audio is typically recorded speech, however singing or lyrics may also be included, for example in the case of a music track or video.

The invention extends to methods, apparatus and/or use substantially as herein described with reference to the accompanying drawings.

Any feature in one aspect of the invention may be applied to other aspects of the invention, in any appropriate combination. In particular, features of method aspects may be applied to apparatus aspects, and vice versa.

Furthermore, features implemented in hardware may generally be implemented in software, and vice versa. Any reference to software and hardware features herein should be construed accordingly.

### BRIEF DESCRIPTION OF THE DRAWINGS

To assist understanding of the present disclosure and to show how embodiments may be put in effect, reference is made by way of example to the accompanying drawings in which:

FIG. 1 is a schematic of a communication system;

FIG. 2 shows a functional schematic of an example user terminal suitable for use in the communication system of FIG. 1;

FIG. 3 is a flow chart of an indexing method;

FIG. 4 is a flow chart of a search method;

FIG. 5 is message sequence chart illustrating a basic example of instant messaging.

### DETAILED DESCRIPTION OF EMBODIMENTS

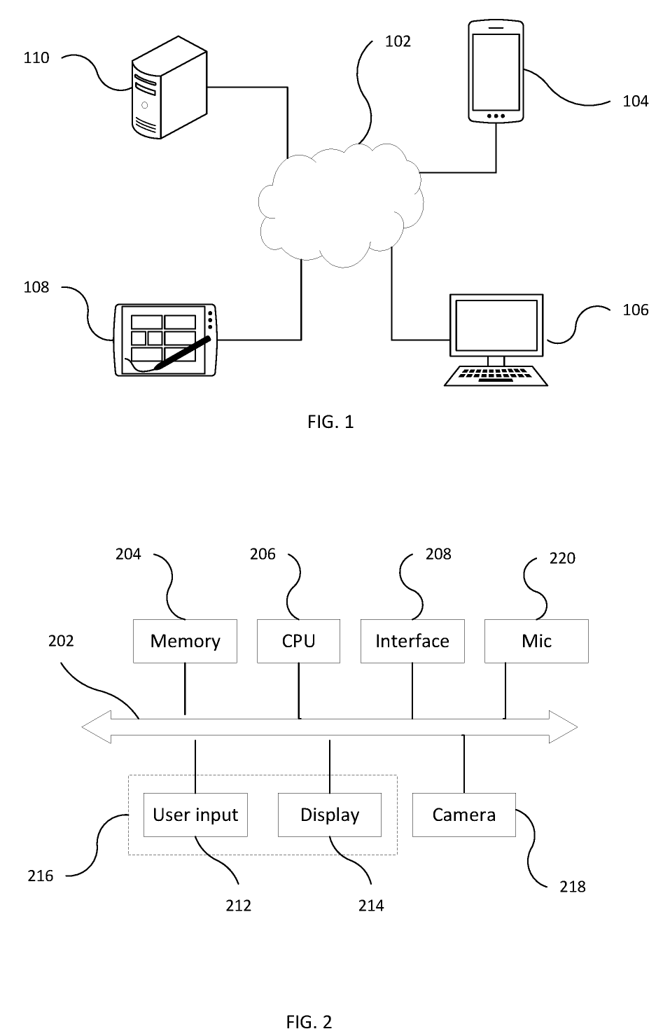

FIG. 1 illustrates an example of a communication system in which media sharing and instant messaging can be implemented. A network 102 enables communication and data exchange between user terminals or devices 104-110 which are connected to the network via wired or wireless connection. The network may be a single network, or composed of one or more constituent networks. For example, the network may comprise a wide areas network such as the internet. Alternatively or additionally, the network 102 may comprise a wireless local area network (WLAN), a wired or wireless private intranet (such as within a company or an academic or state institution), and/or the data channel of a mobile cellular network. In an embodiment a device is able to access the internet via a mobile cellular network.

A wide variety of terminal or device types are possible, including a smartphone 104, a laptop or desktop computer 106, a tablet device 108 and a server 110. It will be understood that multiple instances of each type of device can be connected together via the network or networks. The server may in some cases act as a network manager device, controlling communication and data exchange between other devices on the network, however network management is not always necessary, such as for some peer to peer protocols.

A functional schematic of an example user terminal suitable for use in the communication system of FIG. 1 for example, is shown in FIG. 2.

A bus 202 connects components including a non-volatile memory 204, and a processor such as CPU 206. The bus 202 is also in communication with a network interface 208, which can provide outputs and receive inputs from an external network such as a mobile cellular network or the internet for example, suitable for communicating with other user terminals. Also connected to the bus is a user input module 212, which may comprise a pointing device such as a mouse or touchpad, and a display 214, such as an LCD or LED or OLED display panel. The display 214 and input module 212 can be integrated into a single device, such as a touchscreen, as indicated by dashed box 216.

Further input/output devices may also be provided, for receiving audio and/or video information from the user, such as a microphone 220 and a camera 218. Furthermore, the i/o devices comprise one or more user input devices enabling applications to receive user inputs and selections from the user. An operating system running on the user terminal is an end-user operating system, i.e. designed for user terminals to provide an interface to the end user, to present information from applications to a user through a graphical user interface presented on a display 214, and to receive back inputs to applications from the user through one or more user input devices.

Programs such as an operating system, a web browser, an instant messaging application, and other applications are stored memory in 204 for example can be executed or run by the CPU, to thereby perform the various operations attributed to them. In the case of an IM service, a client is generally provided as separately installed piece of software such as an app, or a browser-based client. The storage on which the operating system, instant messaging application and other application(s) are stored may comprise any one or more storage media implemented in one or more memory units. E.g. the storage means may comprise an electronic storage medium such as an EEPROM (or “flash” memory) and/or a magnetic storage medium such as a hard disk. Note also that the term “processor” as used herein does not exclude that the processor may comprise multiple processing units.

The network interface 208 enables the user terminal to connect to a packet-based network possibly comprising one or more constituent networks. E.g. in embodiments the network may comprises a wide area internetwork such as that commonly referred to as the Internet. Alternatively or additionally, the network 102 may comprise a wireless local area network (WLAN), a wired or wireless private intranet (such as within a company or an academic or state institution), and/or the data channel of a mobile cellular network. To connect to such a network, the network interface 208 may comprise any of a variety of possible wired or wireless means as will be familiar to a person skilled in the art. For example, if the network 102 comprises the Internet, the network interface 120 may comprise a wired modem configured to connect to the Internet via a wired connection such as a PSTN phone socket or cable or fibre line, or via an Ethernet connection and a local wired network. Or alternatively the network interface 208 may comprise a wireless interface for connecting to the Internet via a wireless access point or wireless router and a local (short-range) wireless access technology such as Wi-Fi, or a mobile cellular interface for connecting to the Internet via a mobile cellular network.

The connection to the network via the network interface 208 allows applications running on the user terminal to conduct communications over the network. User terminals such as that described with reference to FIG. 2 may therefore be adapted to send text and/or audio and/or video data, over a network such as that illustrated in FIG. 1 using a variety of communications protocols/codecs, optionally in substantially real time.

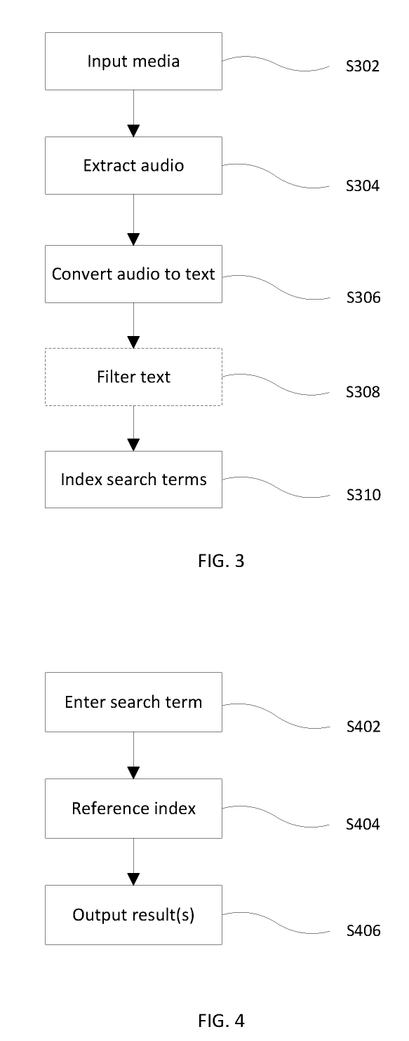

FIG. 3 is a flow diagram illustrating a searching indexing method for multimedia files. In step S302, one or more media files is input or obtained to start the process. Such files will typically be video files, but may also include other files having an audio component including speech or vocals, and therefore may also include audio files. The media file or files may be in a variety of formats, and will typically be compressed, for example in an MP4 format.

The input of media files may be in response to a user instruction to process a specified file or group of files, or it may be performed automatically upon receiving a file, or as part of a routine or maintenance process for example.

In step S304, audio is extracted from the one or more files input in S302. This can be performed by using known processing algorithms to decode/encode/transcode the files as required. The output audio files can be in a number of different formats, and the output format may depend on the input format. It is noted that in that case of audio files input in step S302, then extraction is not required.

In step S306, the extracted audio files undergo audio to text conversion. This can be performed using speech recognition (transcribing) technology which is commercially available. It will be appreciated that different types of transcription offer different accuracies, and may handle for example background noise differently. For example, some transcription services and technologies aim to capture every utterance, while others aim to provide a more readable output, potentially subject to some editing. In the case of automated transcription using computer implemented algorithms, these generally use or require a learning process, and perform better for a particular voice after some training examples.

In the presently described example, media files will usually contain a variety of different voices, and potentially multiple different voices on the same file (for example a video of a group of people having a conversation together). Therefore, algorithms which rely heavily on training data may struggle to provide accurate transcription. However, as will be explained below, a high accuracy transcription may not be required, and acceptable results may be obtained, even if mistakes occur in transcription and even if some words or phrases failed to be recognised.

The conversion or transcription will typically be language specific, and transcription may be provided in multiple different languages (e.g. French, Mandarin, Italian, Spanish). In some examples, transcription software can detect the language from the audio file and operate in an appropriate mode.

Step S308 is an optional step to filter the derived text to remove stop words. Stop words are words or phrases which are very common and which do not usually add any significant or context to a text string. Such words (in English) include “is”, “of”, “the”, “but” etc.

At step S310, the filtered text is used to provide search words or terms to generate a search index for the particular file or files to which those words relate. Not all of the obtained (and possibly) filtered words need to be used and stored as part of the indexing. In some examples, further filtering may occur to select specific words or terms, based on frequency for example, or based on length of word or how common a word is in a given language (for example to avoid words which are not considered stop words, but which are likely to be included in multiple different files if searched). Alternatively, all resulting words can be stored and indexed.

Where words or phrases are repeated, such duplicates may be removed. Alternatively or additionally, the frequency or number of occurrences can be recorded in or in relation to the index, and used as part of the searching process as will be explained below.

Extensions to the above described basic method are possible, to provide enhanced searching and indexing. In addition to providing search terms from text from audio, rich metadata such as the duration of the media file, the location and/or date and time where it was captured or created, and the format of the file can be used, to provide an enhanced search experience.

The search index so created can then be integrated into the multimedia gallery of a user device such as a smartphone or tablet for example.

Taking a specific case as an example to better illustrate this method, an MPEG4 video file having an .mp4 extension is obtained and MediaEncoderLibrary on Android operating system is used to extract the audio, resulting in audio in PCM format. The same library can also be used to extract metadata from the .mp4 file to provide information such as duration, location, format etc.

The audio is converted to a format suitable for the transcribing software, by downsampling from stereo to mono, and reducing the size by taking two bytes of every consecutive 4 bytes from the PCM format. A call can then be made to Microsoft Cognitive Service's Speech API to convert the audio to text. The result is a text file from which stop words are then removed using string replacement.

Using SQL lite FTS (Full Text Search) an index is then created which has each word indexed with the video ID, so that the search on any word provides the video id as a result. The search index can optionally be enhanced by adding the rich metadata extracted from the video. This search index can be integrated in the multimedia gallery of a user device such as a phone or tablet.

The methods described above allow for more efficient and convenient searching of media files, as will be explained in relation to FIG. 4, which is a flow diagram of a method of searching indexed files.

In order to find a particular file or files a user can enter a search term or combination of search terms, at step S402. The term can be a single term or phrase to be matched from audio from the relevant file. For example, if a user has recorded multiple lectures in a mathematics class, the user can search for “calculus” or “integral” to search for videos of lectures where these terms are mentioned.

Combinations of words can be entered as search strings using Boolean operators. For example, a user can search for “calculus OR integral” or “number AND theory” as search strings against text extracted from audio of lecture videos. As noted above, rich metadata can also be included in the search index, so different parameters can also be used and parameters such as date or length can be combined with audio/text derived index terms. Therefore, a user can search for videos which mention “cup cakes” and which are less than five minutes in length for example.

At step S404 the search terms are references against the index or indices to find matches, and at step S406, the matching results are returned to the user in a suitable display format. Considering here only searching for terms derived as per FIG. 3, in examples only those matches meeting all search criteria are displayed, or otherwise provided to a user. In other examples, partial matches may also be provided, or at least an option presented to show partial matches.

As a further possibility, search results may be ranked, and provided in order of ranking. In one example ranking is based on the frequency with which the searched word or phrase is found in the extracted audio of a media file. This can be based on a stored value of frequency as mentioned above in relation to FIG. 3 for example.

The above description is largely device independent, however it should be appreciated that the methods described can be performed at a client device or a server or remote processing resource, or distributed over a combination of the two.

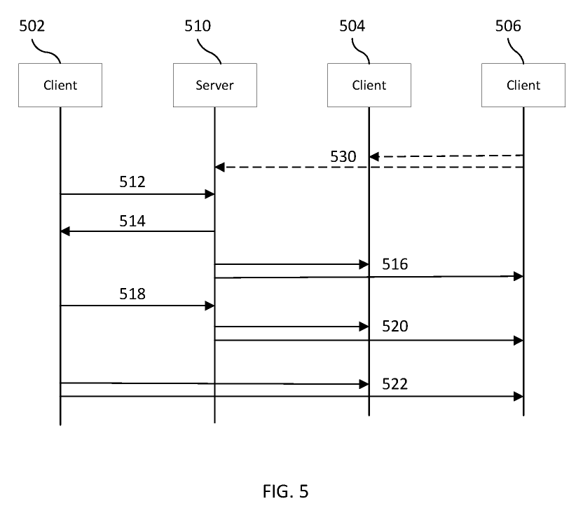

As noted above, one particularly envisioned context for a searching and indexing method as described above is instant messaging (IM). FIG. 5 is message sequence chart illustrating a basic example of instant messaging between a plurality of clients. 502, 504, 506. A client may be a separately installed piece of software, or a browser-based client operating on a user terminal or device, such as mobile phone, tablet, laptop computer or desktop computer.

When a sending user logs in, the corresponding client 502 sends (512) to a server 510 connection info such as IP address and port, and contacts information including details of any groups the sending user is a member of, if this is not already stored at the server. In this example clients 504 and 506 correspond to users who are contacts of the sending client. The server can check which users from amongst the contact information are logged on or online, and can report back (514) to the client 502. Client 502 can update a display to indicate the status of contacts (e.g. whether they are online or not, or the last time they were logged on or online). The server may notify (516) clients corresponding to the contacts information that client 502 is logged in, and optionally provide the connection information of client 502.

The sending user wishes to send an IM to a group, which includes clients 504 and 506. The message is sent (518) to the server. The server can analyse the message to determine the intended recipients, by receiving the name or ID of the group, and looking up members of that group in stored or received contact information and their connection information, and can forward the message appropriately (520).

In the above described method, a hub-spoke architecture is used, with messaged passing between clients via a server, however a peer to peer architecture is a possible alternative. In a peer to peer system, at 514 the server can also provide connection information (eg IP address and port) of contacts who are logged in or online (having been notified of such information from the respective clients, shown dashed line as 530). In this way the client 502 is able to send a message directly (522) to clients 504 and 506, as it has the necessary connection information to access them without the need for a routing intermediary. It is noted that even in a peer to peer session, a server is typically employed to administrate connection information between clients.

Peer to peer architecture is generally more useful for communication where two or more users are connected for a session, such as for a voice call or videoconference for example. A server client, or spoke hub architecture may be more suitable to a text based communication system such as instant messaging.

Messages exchanged in this way may include media files such as audio and video files. Such files may be created by a user with a device such as a smartphone, or can be downloaded from the internet for example. Where media files are included in messages, these may not be transmitted with the message itself, but instead a link is provided allowing the relevant file to be downloaded at the instruction of a user, resulting in multiple media files stored locally on devices. However, as will be understood from FIG. 5, such media content will typically have been passed via a server, which may still retain a copy.

Therefore, it will be understood that the indexing method of FIG. 3 can be distributed between, for example, the client 502 and the server 510 of FIG. 5.

In perhaps the simplest example, all steps of the method of FIG. 3 are performed locally on a user device. However, processing and power usage may be an issue for a mobile device, and it may be desirable for the conversion of audio to text to be performed remotely. In such a case the user device can make a call to a service hosted on a remote device such as a server. The audio file can be provided to a remote transcription service, and the corresponding text file returned. Alternatively, it may be simpler to provide the media file to the remote service provider, for both audio extraction and transcription to be performed remotely.

Considering the discussion of FIG. 5 above, it will be appreciated that in some systems, the source media files may be, or may have been stored at the server at some stage, and therefore such files can be the subject of audio extraction and transcription, without specific instruction from one or more user devices, and possibly without the need for the user device to provide any source files, either base media or extracted audio. In all such examples, it is preferable for the resulting search index to be stored locally on the user device, so that offline searching is supported.

It will be understood that the present invention has been described above purely by way of example, and modification of detail can be made within the scope of the invention. Each feature disclosed in the description, and (where appropriate) the claims and drawings may be provided independently or in any appropriate combination.

The various illustrative logical blocks, functional blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the function or functions described herein, optionally in combination with instructions stored in a memory or storage medium. A processor may also be implemented as a one or a combination of computing devices, e.g., a combination of a DSP and a microprocessor, or a plurality of microprocessors for example. Conversely, separately described functional blocks or modules may be integrated into a single processor. The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, and a CD-ROM.

1. A method of search indexing a media file comprising:
obtaining a media file including an audio component;
extracting the audio component from the media file;
converting recognized language in the extracted audio into text; and
indexing at least some of the text as search terms against the media file.

2. A method according to claim 1, further comprising filtering said converted text to remove some words, and wherein only filtered text is indexed.

3. A method according to claim 2, wherein filtering comprises removing stop words which occur frequently and do not add context.

4. A method according to claim 2, wherein filtering includes removing duplicate words.

5. A method according to claim 3, wherein filtering includes removing duplicate words.

6. A method according to claim 1, further comprising storing information on the frequency of occurrence of words of indexed text.

7. A method according to claim 1, wherein converting recognized language in the extracted audio into text is performed remotely from the obtaining of said media file.

8. A method according to claim 1, further comprising extracting metadata from said media file and indexing extracted metadata against that file.

9. A method according to claim 8, wherein said metadata includes at least one of location, date or time of creation of the media file, or the format of the media file.

10. A method according to claim 1, further comprising integrating said indexed text into a multimedia gallery of a user device.

11. A method according to claim 1, further comprising receiving, from a user, at least one search term, searching said term against the indexed text, and returning matching media files.

12. A method according to claim 11, further comprising ordering said returned files according to frequency of matched search terms.

13. A method according to claim 1, wherein obtaining said media file comprises receiving said file via an instant messaging service.

14. A method according to claim 1, wherein said media file includes music as audio.

15. A computer readable storage medium comprising computer readable instructions which when run on a computer cause that computer to perform a method of search indexing a media file comprising:
obtaining a media file including an audio component;
extracting the audio component from the media file;
converting recognized language in the extracted audio into text; and
indexing at least some of the text as search terms against the media file.

16. A computer readable storage medium according to claim 15, further comprising filtering said converted text to remove some words, and wherein only filtered text is indexed.

17. A computer readable storage medium according to claim 15, wherein filtering comprises removing stop words which occur frequently and do not add context.

18. A computer readable storage medium according to claim 15, further comprising storing information on the frequency of occurrence of words of indexed text.

19. A computer comprising:
a computer readable storage medium comprising computer readable instructions;
a processor connected to the computer readable storage medium and configured to run the computer readable instructions, wherein the instructions are configured when run on the processor cause the computer to perform a method of search indexing a media file comprising:
obtaining a media file including an audio component;
extracting the audio component from the media file;
converting recognized language in the extracted audio into text; and
indexing at least some of the text as search terms against the media file.

20. A computer according to claim 19, the method further comprising filtering said converted text to remove some words, and wherein only filtered text is indexed.
